(19) United States
(12) Patent Application Publication
(10) Pub. No.: US 2013/0238701 A1
(43) Pub. Date: Sep. 12, 2013

(54) Calendar Matching-up Social Network System And Method For Performing The Same

(71) Applicants: Ko-Chung Lee, Taipei City (TW); Pei-Chun Chen, Taipei City (TW); Han-Chung Chiang, Taipei City (TW)

(72) Inventors: Ko-Chung Lee, Taipei City (TW); Pei-Chun Chen, Taipei City (TW); Han-Chung Chiang, Taipei City (TW)

(21) Appl. No.: 13/460,590

(22) Filed: Apr. 30, 2012

(30) Foreign Application Priority Data
Apr. 29, 2011 (TW) 100115275

(51) Int. Cl. H04L 29/06

(52) U.S. Cl. CPC H04L 65/403
USPC 709/204

(57) ABSTRACT

A calendar matching-up social network system and a method for performing the same are introduced, which do not only periodically gather and join at least one calendared data under various different computerized architectures into a web-based calendar provided from a specified community site for respective member but also actively intermediate and collect registering data of all of the members who have the same or similar specific information as contained in the gathered web-based calendars. Then, the system provides an intermediated message to the web-based calendar of the specified community site with respect to the respective member registering data with the same or similar specific information. This will facilitates establishment of a social relationship among those members having the same or similar specific information to share the specific information via the specified community site.

### BACKGROUND OF THE INVENTION

1. Field of the Invention

The present invention relates to a calendar matching-up social network system and a method for performing the same, and especially to, a calendar matching-up social network system and a method for performing the same, which join and intermediate various calendars of different users.

2. Description of the Prior Art

In the network technology development, the earliest design merely is dedicated to a specific internal networking architecture which makes interconnections among various computerized systems with different software/hardware via wirings to share message and source with each other. Nevertheless, by successive network technology development for the past decades, the network technology has not only limited to a pure office tool and has evolved to a virtual socializing tool of human societies. Various community sites (Social Network Sites) or called “virtual social network” based on the Internet, e.g. Facebook, Twitter or Myspace, are born, accordingly. Through the internet, those members of the community sites can create, share, exchange various digital information with each other, including, for example, images, pictures, sounds, diagrams, programs, articles, news, and even a real-time video recording and broadcasting. These have greatly affected the people life, including social activity. To meet different social activities in the human societies, various kinds of social networking service (SNS) are contiguously developed, like a chartroom, a web mail, a blog, a forum and so forth. Providence of the social networking service mostly relies on execution of various kinds of web-based applications. For example, a Facebook member/group can enter a web-based calendar dedicated thereto to make an appointment or record data involving a time/schedule/event/activity/place with relation to an appointment. However, by following the progress of various technologies, the technical barriers formed among different technologies or information architectures become higher, accordingly, so that an ordinary people can not readily join them to synchronized manipulation. For example, for the same user, he/she might simultaneously own a calendar provided on the Facebook website via the internet, a calendar provided by a search portal website like Google, a calendar like ‘iCal’ dedicated to a smart phone, a calendar provided by a webmail software like ‘Outlook’, and the like calendar under different information architectures. If the user would like to record the same thing for the same time, the user might need to individually click into the Facebook website, enter the smart phone having the dedicated calendar software and the webmail software as ‘Outlook’, so as to record/update one by one with repeating operation. This would invoke the manipulation very inconvenient.

Besides in a common web socialization, unless the user has predicted someone's Blog website where the user can click to browse or the user needs taking time in advance to seek an event what is the user interested in, through a search portal website as Yahoo or Google by keying specific wording, it is very difficult to timely know whether any other people are interested in the same event/activity, e.g. a birthday party, group purchases, fans collections and so forth. This would make handicap in sociality.

### BRIEF SUMMARY OF THE INVENTION

To resolve said drawbacks of the conventional techniques, a primary objective of the present invention is to provide a calendar matching-up social network system and a method for performing the same, which are capable of generating a number of member registering data via a specific community site. Then, for the respective member registering data, the calendar matching-up social network system does not only periodically gather the respective calendared data provided under various different computerized architectures into a web-based calendar of the specific community site corresponding to the respective member for data updating/recording but according to a number of specific information, such as a time/an event/a place, contained in the respective calendared data also actively intermediates and collects all of the member registering data which have the same or similar specific information. Furthermore, the calendar matching-up social network system provides an intermediated message to the web-based calendar of the specific community site corresponding to each one of those member registering data having the same or similar specific information, whereby a social relationship among those members having the same or similar specific information can be established via the specified community site.

To accomplish the above inventive objective, the present invention provides a calendar matching-up social network system applied for a specific community site server, which primarily comprises a application library and a remote database, wherein the application library further includes a member generating unit, a calendared data gathering unit, a sociality matching-up unit and an output interface unit.

The member generating unit correspondingly generates a member registering data based on a data of at least one existing member provided from the specific community site server. Based on said member registering data, the calendared data gathering unit actively gathers at least one calendared data provided under the same or different computerized architectures and then joins the at least one calendared data into a web-based calendared data of the specific community site server corresponding to the member registering data and thereby establishes at least one member event chart. According to a number of specific information contained in the at least one member event chart, the sociality matching-up unit actively collects the member registering data, which is related to the same or similar specific information, from the at least one member event chart and thereby establishes at least one member matching-up chart. The output interface unit is configured to output the at least one member matching-up chart to a web-based calendar of the specific community site server corresponding to each one of the member registering data which is related to the same or similar specific information. The database server is employed to store the member registering data and the at least one member event chart corresponding to the member registering data therein.

Besides the present invention further provides a method for performing a calendar matching-up social network system applied in a specific community site server, which comprises the following steps of:
based on a data of at least one existing member provided from the specific community site server, utilizing a member generating unit correspondingly generating a member registering data and storing the member registering data into a database;
based on said member registering data, utilizing a calendared data gathering unit actively gathering at least one calendared data provided under the same or different computerized architectures, and merging the at least one calendared data into a web-based calendared data of the specific community site server corresponding to the member registering data and thereby establishing at least one member event chart, and then storing the at least one member event chart into a location on the database which corresponds to said member registering data;
according to a number of specific information contained in the at least one member event chart, utilizing a sociality matching-up unit, actively gathering the member registering data, which is related to the same or similar specific information, from the at least one member event chart and thereby establishing at least one member matching-up chart; and
outputting the at least one member matching-up chart via an output interface unit to a web-based calendar of the specific community site server corresponding to each one of the member registering data which is related to the same or similar specific information.

The advantages and novel features of the invention will become more apparent from the following detailed description of a preferred embodiment when taken in conjunction with the accompanying drawings.

### BRIEF DESCRIPTION OF THE DRAWINGS

The present invention may best be understood through the following description with reference to the accompanying drawings, in which:

FIG. 1A shows a schematic diagram of a calendar matching-up social network system according to a preferred embodiment of the present invention applied in the internet architecture;

FIG. 1B shows an architectural schematic diagram of the calendar matching-up social network system according to the preferred embodiment of the present invention;

FIG. 2 shows a schematic diagram of a member event chart generated by the calendar matching-up social network system according to the preferred embodiment of the present invention;

FIG. 3 shows a schematic diagram of a web-based calendar where a number of member registering data related to the same or similar specific information output by the calendar matching-up social network system according to the preferred embodiment of the present invention;

FIG. 4 shows a schematic diagram of a member matching-up chart generated by the calendar matching-up social network system according to the preferred embodiment of the present invention;

FIG. 5 shows a flow chart of a member-registering procedure of a method of performing the calendar matching-up social network system according to the preferred embodiment of the present invention; and

FIG. 6 shows a flow chart of an actively matching-up procedure of the method of performing the calendar matching-up social network system according to the preferred embodiment of the present invention.

### DETAILED DESCRIPTION OF THE INVENTION

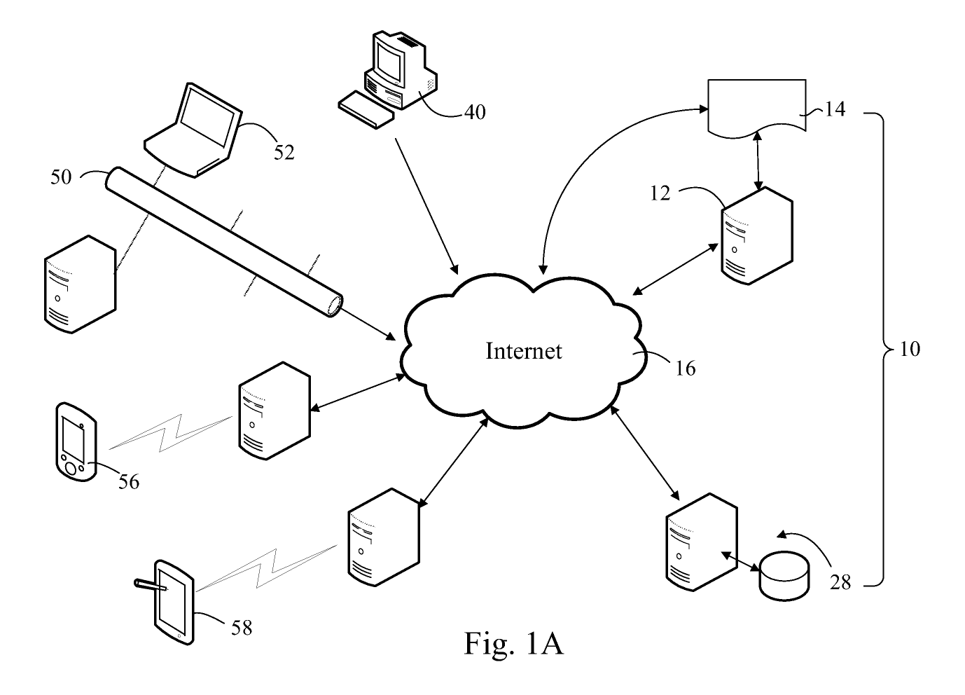

Firstly referring to illustration shown in FIG. 1A, a calendar matching-up social network system 10 according to a preferred embodiment of the present invention is applied for a specific community site server 12 and linked to the internet 16 in architecture, which primarily includes a application library 14 and a remote database 28, wherein the application library 14 is configured in the specific community site server 12 and accesses the remote database 28 via the internet 16. In this embodiment, the specific community site server 12 is realized as the Facebook website server and the remote database 28 is realized as a database server. As shown in FIG. 1A, any one existing member (e.g. an existing member/group of the Facebook) belonging to the specific community site server 12 can utilizes various computerized architectures located on far ends, including, for example, a desktop computer 40, a notebook computer 52, a mobile phone 56 or a handset electronic apparatus 58 (like PDA), via an area network 50 or a wireless telecommunication network server linked to the internet 16 and thereby acquires a web-based data provided from the specific community site server 12. By the application library 14 where the web-based data is linked, any one existing member of the specific community site server 12 can simultaneously determine whether to activate the calendar matching-up social network system 10 of the present invention so as to actively match up social activities among the existing members of the specific community site server 12.

Further referring to FIGS. 1A and 1B, the application library 14 primarily includes a member generating unit 20, a calendared data gathering unit 22, a sociality matching-up unit 24 and an output interface unit 26, wherein based on a data of at least one existing member provided from the specific community site server 14, i.e. an account data allocated on the specific community site server 14 (e.g. an account of the Facebook), the member generating unit 20 correspondingly generates a member registering data including the data of the at least one existing member and a number of setting values related thereto. The related setting values are parameters used by any one of the existing members of the specific community site server 12 (e.g. the existing member/group of the Facebook) for manipulating the various computerized architectures, such as a mail account and password of a search website (e.g. Google), a calendar (e.g. iCal) parameter dedicated of a specific smart phone and a parameter of webmail software (e.g. Outlook).

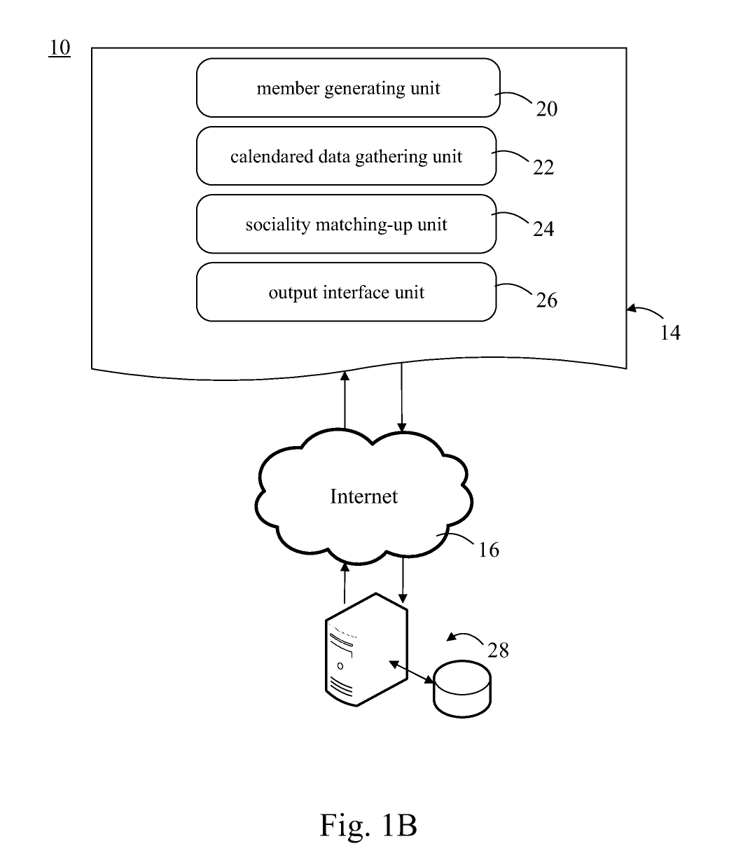

Based on said member registering data, the calendared data gathering unit 22 actively gathers at least one calendared data provided under a variety of the same or different computerized architectures which are manipulated by at least one of the existing members of the specific community site server 14, wherein the at least one calendared data contains a number of specific information (e.g. a time information, an event information and a place information). Then, the calendared data gathering unit 22 joins the at least one calendared data into a web-based calendared data of the specific community site server 12 where the member registering data corresponds, and thereby establishes a member event chart. Said same or different computerized architectures, except for those as shown in FIG. 1A including a desktop computer 40, a notebook computer 52, a mobile phone 56, a handset electronic apparatus 58 (like PDA) and various types of hardware devices, further includes a documentation architecture, an application and/or operating system and various types of software configurations, wherein the operating system further including a networking operating system, a computerized operating system and a smart phone operating system, and the application includes a networking application and/or a computer application. For example, based on the setting values contained in said member registering data, the calendared data gathering unit 22 actively gathers a calendared data of the search website mail as Google, a calendared data as iCal dedicated of a smart phone and a calendared data of a webmail software as Outlook, as what the existing members of the Facebook website remotely use, into a web-based calendared data of the Facebook website. Then, the calendared data gathering unit 22 produces a member event chart as shown in FIG. 2, based on said gathered web-based calendared data.

It is found in FIG. 2 that substantially the member event chart contains the member registering data (as the member 1) therein, and with relation to the member registering data, all of said gathered calendared data (as the calendared data of the Google mail, the calendared data dedicated for a smart phone, the calendared data of the Outlook and Facebook calendared data used by the member). Meanwhile, the respective calendared data records a number of specific information therein. These specific information like some information recorded on a common calendar by the user, primarily containing each time information (as the time 1, 2, 3 . . . ), each place information (as the places, 1, 2, 3 . . . ) and each event information (as the events 1, 2, 3 . . . ). For example, a time information is “Feb. 22, 2011”, an event information is “signing session”, and a place information is “Taipei”. However, the time information is not limited to a time and can be a period.

Referring to FIGS. 1A and 1B, the remote database 28 realized as a remote database server is linked to the application library 14 via the internet 16 so that the application library 14 can store/acquire the member registering data and a member event chart corresponding to the member registering data (as shown in FIG. 2) in/from the remote database 28. It means that for the respective member registering data, the application library 14 can correspondingly generates a member event chart to store within the remote database 28, and the calendared data gathering unit 22 of the application library 14 periodically updates the member event chart corresponding to respective member registering data with reliance on calendar variances.

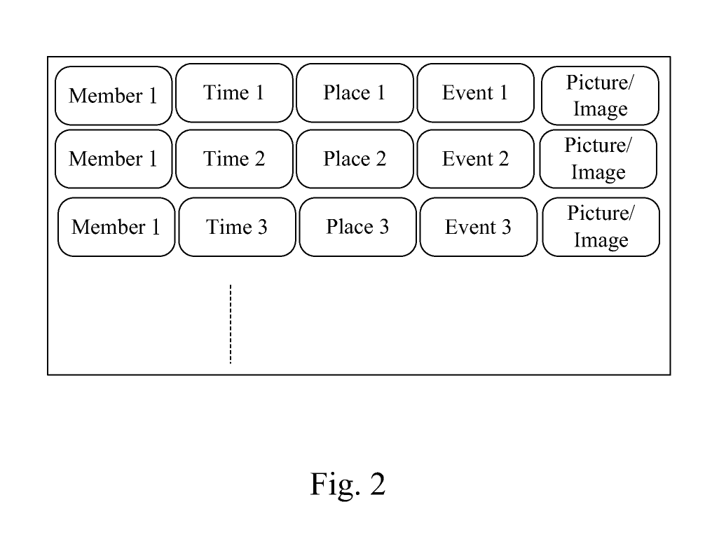

Referring to FIGS. 1A and 1B, the sociality matching-up unit 24 of the application library 14 actively determines whether there are the same or similar specific information (as a time information, an event information or a place information and the likes) found in a number of member event charts of all of different member registering data in the remote database 28. If so, the member registering data that are related to the same or similar specific information are actively gathered from these member event charts and are counted in amounts. Then, the amount is output to a web-based calendar of the specific community site server 12 corresponding to the respective member registering data related to the same or similar specific information via the output interface unit 26 (as a graphic user interface or human-computer interface). For example, as shown in FIG. 3, when a web-based calendar of the specific community site server 12 corresponding to the respective member registering data related to the same or similar specific information (as the Facebook) is opened, the web-based calendar shows that there are 72 people matching the “birthday party” event on the date of the seventh in a calendar time, there are 13 people matching the “interview” event on the eleventh 11, and there are 106 people matching the “finding a designer” event on the sixteenth. If not finding any same or similar specific information, the sociality matching-up unit 24 will contiguously make analysis and gathers in the remote database 28.

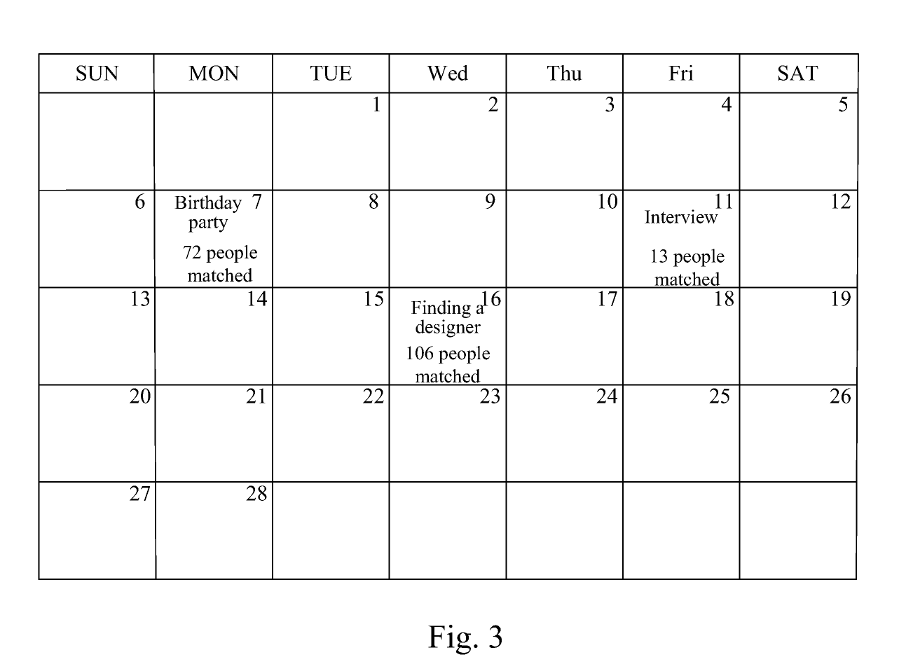

Besides while the sociality matching-up unit 24 receives an instruction message transmitted from the web-based calendar of the specific community site server 12 corresponding to the respective member registering data related to the same or similar specific information, for instance, one of the related members clicks a date column of the seventh in the web-based calendar as shown in FIG. 3, the sociality matching-up unit 24 further establishes a member matching-up chart regarding those 72 people. It should note that in this embodiment, the member matching-up chart is just a temporary save file and would not be stored to the remote database 28. However, in another embodiment, the member matching-up chart is further stored to the remote database 28. For example, since the same time 1 and the same event 1 are respectively found from a number of member event charts regarding a number of different member registering data (e.g. the members 1, 2, 3 . . . ), the number of different member registering data (as the members 1, 2, 3 . . . ) having the same time 1 and the same event 1 is gathered into a member matching-up chart as shown in FIG. 4. If a plurality of the partial same or similar specific information, such as the same time and event information or the same time and place information, are found from a number of member event charts of all of the member registering data in the remote database 28, a number of member matching-up charts can be established.

Each of said member matching-up charts can be output via the output interface unit 26 to the web-based calendar of the specific community site server 12 corresponding to the respective member registering data (as the members 1, 2, 3 . . . ) related to the same or similar specific information and thereby be elected by any one of the related members. Since any one of the social data (including a time, event or place) recorded/added by the members in these networking calendars or scheduling such as the Google Calendar or Facebook Calendar is pre-output to save into the remote database 28. By the calendar matching-up social network system 10 of the present invention based on matching-up of the same social time or an approaching period, the members can search the past or the present social data such as a member name, activity detail and so forth from the social activities data stored within said member matching-up chart, and thereby share the related social data or further add other social data like image files. Thus, the calendar matching-up social network system 10 of the present invention can facilitate rapid introductions of the members with arrangement of the similar sociality into each other through networking and therefore establish sociality with each other. Furthermore, the calendar matching-up social network system 10 of the present invention is not limited to usage of a specific social network sites such as Facebook.com or Myspace.com and capable of being applied for any other web socialization platform or on-line social networking.

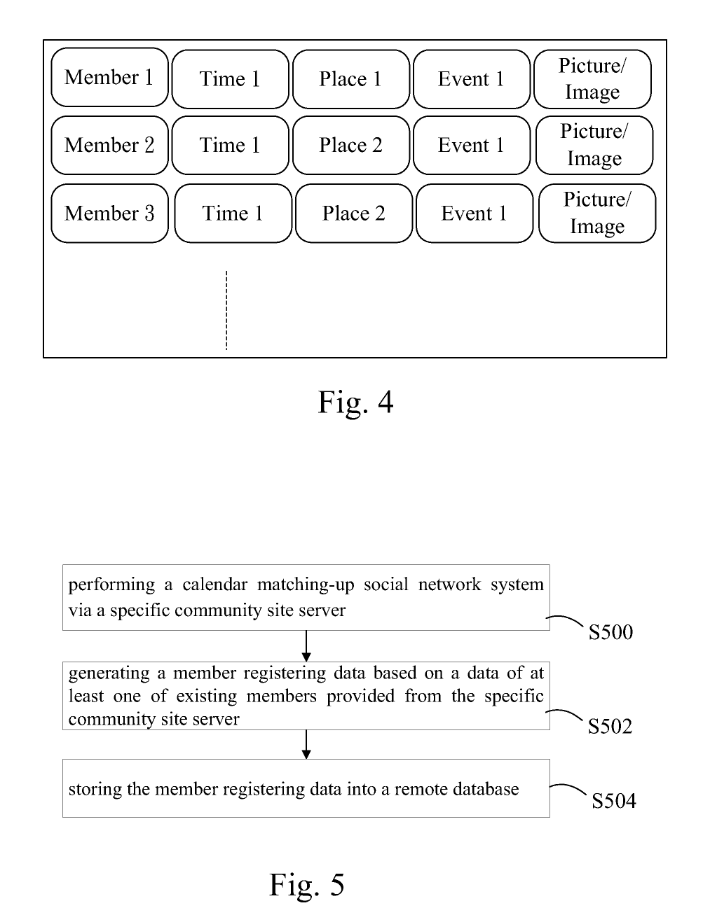

Besides the present invention provides a method of performing a calendar matching-up social network system as applied in a specific community site server 12. The method comprises a member-registering procedure. For easily understanding, the member-registering procedure can refer to an illustration shown in FIG. 5, as accompanying introductions of the respective components in FIGS. 1A and 1B, and comprises the following steps of:
in step S500, performing a calendar matching-up social network system 10 via the specific community site server 12 and the internet 16;
in step S502, utilizing a member generating unit 20 of the calendar matching-up social network system 10 to correspondingly generate a member registering data based on a data of at least one of existing members (e.g. an account of an existing member/group of the Facebook) provided from the specific community site server 12, wherein the member registering data includes a number of related setting values which are realized as parameters used by any one of the existing members of the specific community site server 12 (e.g. the existing member/group of the Facebook) to manipulate the various computerized architectures (e.g. a mail account and password of a search website as Google, a calendar as iCal parameter dedicated of a specific smart phone and a parameter of webmail software as Outlook), or periodically gathered from a data zone by running under the same or different computerized architectures (as a desktop computer 40, a notebook computer 52, a mobile phone 56 or a handset electronic apparatus 58 located on far ends, as shown in FIG. 1A); and
in step S504, storing the member registering data into a remote database 28 of the calendar matching-up social network system 10 by the member generating unit 20.

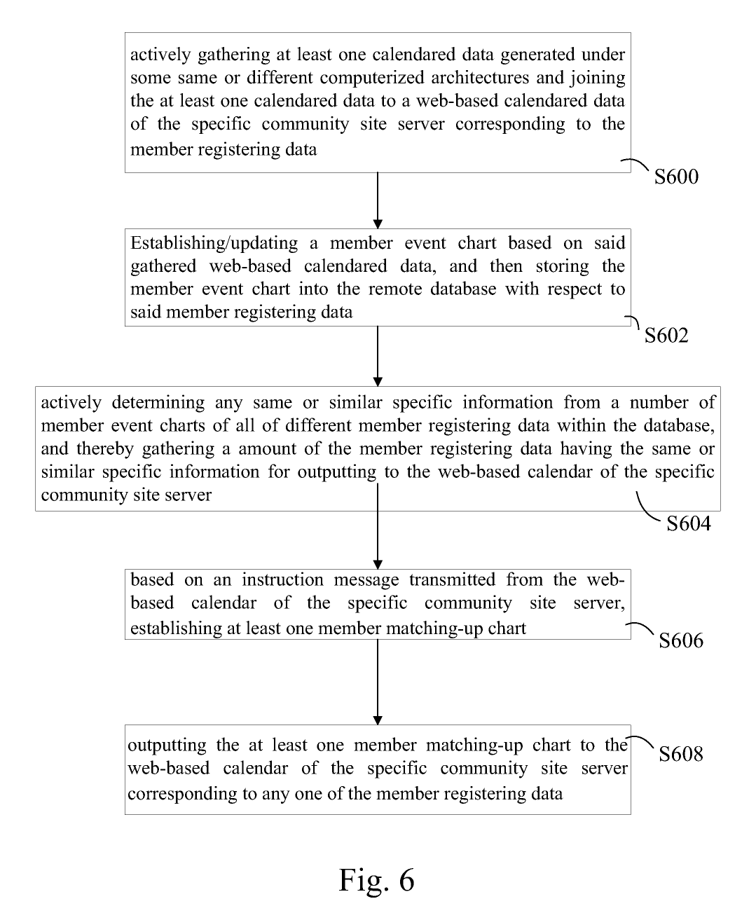

The method of performing the calendar matching-up social network according to the present invention further comprises an actively matching-up procedure applied for a specific community site server 12. For easily understanding, the actively matching-up procedure can refer to an illustration shown in FIG. 6, as accompanying introductions of the respective components in FIGS. 1A and 1B, and comprises the following steps of:
in step S600, utilizing a calendared data gathering unit 22 of said calendar matching-up social network system 10 to actively gather at least one calendared data, based on the related setting values of said member registering data, from the data zone used under the same or different computerized architectures (as a desktop computer 40, a notebook computer 52, a mobile phone 56 or a handset electronic apparatus 58 located on far ends, as shown in FIG. 1A), wherein the at least one calendared data contains a number of specific information (e.g. a time information, an event information and a place information); and then joining the at least one calendared data into a web-based calendared data of the specific community site server 12 corresponding to the member registering data;
in step S602, utilizing the calendared data gathering unit 22 to establish/update a member event chart (as shown in FIG. 2) based on said gathered web-based calendared data, and then storing the member event chart into the remote database 28 with respect to said member registering data;
in step S604, utilizing a sociality matching-up unit 24 of said calendar matching-up social network system 10 to actively determine whether any same or similar specific information (as the time information, the event information and/or the place information) is found or not from a number of member event charts of all of different member registering data within the remote database 28; If so, utilizing the sociality matching-up unit 24 to actively gather a number of member registering data related to the same or similar specific information and to count a amount of the related member registering data having the same or similar specific information, and then outputting the amount via the output interface unit 26 to the web-based calendar of the specific community site server 12 (as shown in FIG. 3) corresponding to the respective member registering data related to the same or similar specific information; otherwise, if not, utilizing the sociality matching-up unit 24 to contiguously determine and gather whether any same or similar specific information is found or not;
in step S606, based on an instruction message transmitted from the web-based calendar of the specific community site server 12 corresponding to the respective member registering data related to the same or similar specific information, utilizing the sociality matching-up unit 24 to establish at least one member matching-up chart (as shown in FIG. 4); and
in step S608, outputting the at least one member matching-up chart via the output interface unit 26 to the web-based calendar of the specific community site server 12 corresponding to any one of the member registering data related to the same or similar specific information.

Accordingly, the calendar matching-up social network system 10 of the present invention can actively intermediate and gather all of the member registering data which have the same or similar specific information, and then distribute said intermediated message into a number of web-based calendars of the specific community site server 12 corresponding to each member registering data having the same or similar specific information, and thereby facilitate establishments of social relationships among the members having the same or similar specific information via the specific community site server 12.

It is to be understood, however, that even though numerous characteristics and advantages of the present invention have been set fourth in the foregoing description, together with details of the structure and function of the invention, the disclosure is illustrative only, and changes may be made in detail within the principles of the invention to the full extent indicated by the broad general meaning of the terms in which the appended claims are expressed.

What is claimed is:

1. A calendar matching-up social network system applied in a specific community site server, and comprising:
a member generating unit correspondingly generating a member registering data, based on a data of at least one existing member provided from the specific community site server;
a calendared data gathering unit actively gathering at least one calendared data generated under some same or different computerized architectures, based on said member registering data, and joining the at least one calendared data to a web-based calendared data of the specific community site server corresponding to the member registering data, and thereby establishing at least one member event chart;
a sociality matching-up unit, according to a number of specific information contained within the at least one member event chart, actively gathering a member registering data, related to the same or similar specific information, from the at least one member event chart, and thereby establishing at least one member matching-up chart; and
an output interface unit configured to output the at least one member matching-up chart to the web-based calendar of the specific community site server corresponding to the respective member registering data related to the same or similar specific information.

2. The calendar matching-up social network system as claimed in claim 1, wherein the member registering data includes an account data and a number of setting values dedicated to the at least one existing member in the specific community site server.

3. The calendar matching-up social network system as claimed in claim 1, wherein the same or different computerized architectures comprise documentation architectures, an application and/or an operating system.

4. The calendar matching-up social network system as claimed in claim 3, wherein the operating system comprises a networking operating system, a computerized operating system and a smart phone operating system.

5. The calendar matching-up social network system as claimed in claim 3, wherein the application comprises a networking application and/or a computerized application.

6. The calendar matching-up social network system as claimed in claim 1, wherein the number of specific information contained within the at least one calendared data includes a time information, an event information and/or a place information.

7. The calendar matching-up social network system as claimed in claim 1, further comprising a database server which is employed to store the member registering data and the member registering data corresponding to the at least one member event chart therein.

8. The calendar matching-up social network system as claimed in claim 1, wherein the at least one member matching-up chart comprises the same or similar specific information and the member registering data related to the same or similar specific information.

9. The calendar matching-up social network system as claimed in claim 1, wherein the output interface unit is a graphic user interface or a human-computer interface.

10. A method of performing a calendar matching-up social network system applied in a specific community site server, and the method comprising the following steps of:
utilizing a member generating unit, based on a data of at least one existing member provided from the specific community site server, correspondingly generating a member registering data, and storing the member registering data into a database;
utilizing a calendared data gathering unit, based on said member registering data, actively gathering at least one calendared data generated under some same or different computerized architectures, and joining the at least one calendared data into a web-based calendared data of the specific community site server corresponding to the member registering data, and thereby establishing at least one member event chart and storing the at least one member event chart into the database with respect to said member registering data;
utilizing a sociality matching-up unit, according to a number of specific information contained within the at least one member event chart, actively gathering a member registering data, related to the same or similar specific information, from the at least one member event chart, and thereby establishing at least one member matching-up chart; and
outputting the at least one member matching-up chart via an output interface unit to the web-based calendar of the specific community site server corresponding to the respective member registering data related to the same or similar specific information.

11. The method as claimed in claim 10, further comprising the following steps of:
(1) utilizing the sociality matching-up unit to determine whether any same or similar specific information is found from all of the member event charts of the database;
(2) if so, counting a amount of the member registering data related to the same or similar specific information and the amount via the output interface unit outputting to the web-based calendar of the specific community site server corresponding to the respective member registering data related to the same or similar specific information; and
(3) if not, returning to the step (1).

12. The method as claimed in claim 11, further comprising the following steps of:
based on an instruction message transmitted from the web-based calendar of the specific community site server corresponding to any one of the member registering data related to the same or similar specific information, utilizing the sociality matching-up unit to establishing the at least one member matching-up chart; and
outputting the at least one member matching-up chart via the output interface unit to the web-based calendar of the specific community site server corresponding to any one of the member registering data related to the same or similar specific information.

13. The method as claimed in claim 12, wherein the at least one member matching-up chart is a temporary data file which is in non-save situation for the database.

14. The method as claimed in claim 10, wherein the database is a database server.
